(19) United States
(12) Patent Application Publication
(10) Pub. No.: US 2013/0194089 A1
(43) Pub. Date: Aug. 1, 2013

(54) INTEGRATED BABY ON BOARD ALARM

(71) Applicant: CESAR AUGUSTO ESTRADA, Miami, FL (US)

(72) Inventor: CESAR AUGUSTO ESTRADA, Miami, FL (US)

(21) Appl. No.: 13/360,169

(22) Filed: Jan. 27, 2012

(51) Int. Cl. B60Q 1/00; G08B 17/00

(52) U.S. Cl. 340/457.1; 340/457; 340/584

(57) ABSTRACT

A wireless alarm for an automobile comprising a wireless carbon dioxide/smoke sensor, a wireless temperature sensor, a wireless movement sensor, at least one wireless warning electronic display, at least one wireless alarm buckle adapter, and a processor, said processor further comprising a wireless transmitter, said transmitter emitting at least one signal to the internet; wherein, said processor identifies that one of said wireless sensors is tripped and submits at least one signal to alert that a person or child is left inside the vehicle.

### FIELD OF THE INVENTION

The present invention relates to the art of alarms.

### STATEMENT REGARDING FEDERALLY-SPONSORED RESEARCH AND DEVELOPMENT

Not applicable.

### BACKGROUND OF THE INVENTION

This invention relates to human body sensing systems. The invention is a self-activating device which emit a least one signal when the transmission control handle have been set in parking position, an emits at least another signal to alert authorities or someone else when a person is left unattended in a motorized car cabin, and to advise during the street car traffic movement that a child is onboard.

Cabin cars are designed to protect human, pets, and article from the weather and others negative facts. Once the car is acclimated, i.e. without air or heat, the cabin temperature rises or decreases and may turn to a range that the human body can't withstand. The cabin becomes a death trap.

When a child or elder person is left in a cabin car and the weather temperature exceed the limits of the human body, a tragedy can occur due to the dehydration or blood freeze.

Usually, a child is transported in a baby seat. State laws forces baby seats to be secured in the rear car seat, and usually when a driver steps-down from the car, it is possible to forget that a baby is left in the back of the car. Similarly, an elderly person could be left under similar circumstances.

Several devices have been created to protect humans from unintentional abandonment inside of a car cabin. These inventions generally are composed of an alarm systems which alerts the driver or other persons. These devices are generally very complex, which requires experts for its installation and extensive time of labor. Some of them protect only from leaving the child in the cabin car but does not warn other cars that an infant is being transported in the car, or warn as soon as the driver parks the car.

One of the problems, is the complexity of installation of current alarm systems. Wires have to be routed throughout the vehicle. Most of the alarm systems are very complex requiring multiple people to install them. Cables are easily nicked and damaged. Furthermore, if a cable is damaged the entire alarm must be reinstalled, or changed. This costs a lot of money and time.

Therefore, it can be appreciated that there exists a need for a new and improved system and apparatus for the safe transportation and warning of children left inside a car, which eliminates false alarms while providing for a maximally reliable monitor of a departing driver. Also to alert others driver on the street or traffic movement of the presence of an infant in a car cabin.

### BRIEF DESCRIPTION OF THE SEVERAL VIEWS OF THE DRAWINGS

The foregoing summary, as well as the following detailed description of the invention, will be better understood when read in conjunction with the appended drawings. For illustrating the invention, the figures are shown in the embodiments that are presently preferred. It should be understood, however, that the invention is not limited to the precise arrangements and instrumentalities shown. In the drawings:

FIG. 1 is at least one embodiment of the invention, namely the overall distribution of the components of the system.

FIG. 1A is close up of the wireless buckle adapter.

FIG. 1B is close up of the processor and the sensors of the system.

FIG. 2 is at least one embodiment of the invention, namely a perspective view of the present invention showing the buckle adapter.

FIG. 3 is at least one embodiment of the invention, namely a perspective view of the present invention showing the buckle adapter.

FIG. 4 is at least one embodiment of the invention, namely a perspective view of the present invention showing the displays.

FIG. 5 is at least one embodiment of the invention, namely a perspective view of the present invention showing the displays.

FIG. 6 is at least one embodiment of the invention, namely a perspective view of the present invention showing the displays.

FIG. 7 is at least one embodiment of the invention, namely a perspective view of the present invention showing the sensors working.

FIG. 8 is at least one embodiment of the invention, namely a perspective view of the present invention showing the sensors working.

FIG. 9 is at least one embodiment of the invention, namely a flow chart diagram schematic of the present invention showing the system components.

### DESCRIPTION OF THE INVENTION

The present invention depicts an inventive solution to the fore mentioned issues related to how to alert that a person is inside a vehicle.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein, the term “wireless” or “cordless” refers to Amateur radio Land Mobile Radio or Professional Mobile Radio: TETRA, P25, OpenSky, EDACS, DMR, dPMR Cordless telephony: DECT (Digital Enhanced Cordless Telecommunications) Cellular networks: 0G, 1G, 2G, 3G, Beyond 3G (4G), Short-range point-to-point communication : Wireless microphones, Remote controls, IrDA, RFID (Radio Frequency Identification), TransferJet, Wireless USB, DSRC (Dedicated Short Range Communications), EnOcean, Near Field Communication Wireless sensor networks: ZigBee, EnOcean; Personal area networks, Bluetooth, TransferJet, Ultra-wideband (UWB from WiMedia Alliance). Wireless networks: Wireless LAN (WLAN), (IEEE 802.11 branded as Wi-Fi and HiperLAN), Wireless Metropolitan Area Networks (WMAN) and (LMDS, WiMAX, and HiperMAN) or any combination thereof.

In accordance with the present invention a wireless warning method and apparatus to protect the occupant in the cabin of a motorized vehicle while the engine vehicle is running or in off.

The invention provides a wireless device that alerts the driver or somebody else when a person has been left in the car-seat, the engine has been turned off and the conditions of the car environment cabin represents a risk to the cabin occupants.

In one embodiment of the invention, the device includes a wireless carbon monoxide detector and a smoke detector connected to the alarm system.

In another embodiment, the invention comprises an wireless occupant detection apparatus for detecting the presence of an occupant within a child-seat or body located within a vehicle. The invention further, comprises at least two multiple-angle light reflectors attached to the child-seat back side, and to the back seat.

In yet another embodiment, the invention comprises a wireless source emitter, which emits a wireless signal at a particular frequency which is reflected through a reflective surface and receive by a sensor connected electronically to the alarm. When the signal emitted to the reflective surface is interrupted for the presence of an infant, baby, or for a person seated in the rear seat, an alarm signal is emitted.

When the environment conditions represent a risk to the occupants, and the ignition switch is either turned to the on or off position and a pre-set time passes, a wireless alarm signal is emitted. The environmental conditions of the cabin are sensed by a temperature and a carbon monoxide sensor.

In one embodiment of the invention, the alarm comprises a processor that sends wireless signals to the car's horn and lights, but also to a radio antenna which produce a wireless signal to connecting to the internet by a centralized server. This emergency signal will be distributed to at least one cellular phone and alert fire rescue. The system will not only warn the driver, anyone else in its surrounding to rescue the person left in the cabin vehicle, and unlock the doors.

When the alarm is active, the processor provides this invention a unique way to flash the car's rear and front lights with a particular flashing frequency. This in cooperation with state laws can be associated to a particular emergency, in this case identified with an infant or person left in a cabin car needing of immediate assistance.

In another embodiment, the invention comprises a male-female wireless alarm-buckle adapter which is received within the female receptacle seat belt. This alarm-buckle contains a wireless electronic antenna linked to the alarm system. The invention includes a seat belt specifically marked with a sign reading “baby on board” or other visible figures or warning sign, that marks the need to be coupled in order to secure the person or child. When the belt is secured, the alarm-buckle adapter allows the alarm system to be in activated mode.

In another embodiment, the invention includes a parking-position handle transmission display located in the dash or at front of driver. This display is connected to the handle by and electric contact for the warning to the departing driver in the presence of an infant in the seat located on the rear car seat, or a person secured with the seat belt secured in the alarm-buckle adapter.

In another embodiment, a wireless windshield display for alerting other drivers on the street and traffic movement of the presence of an infant inside the vehicle.

This invention ingeniously utilizes existing parts for its performance, these comprise the battery, front and tail lights, electric door locks, horn or speakers, and electrical wires.

As it has been outlined, rather broadly, the more important features of the invention will be explained in the detailed description that follows. There are, of course, additional features of the invention that will be described hereinafter and which will form the subject matter of the claims appended hereto.

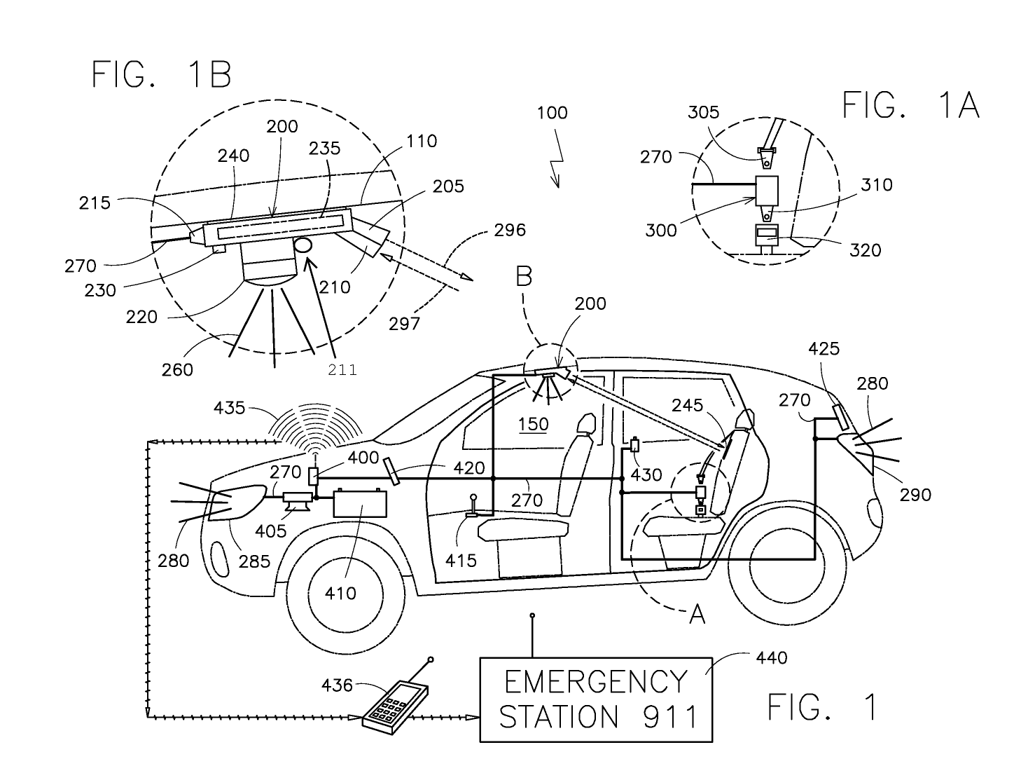

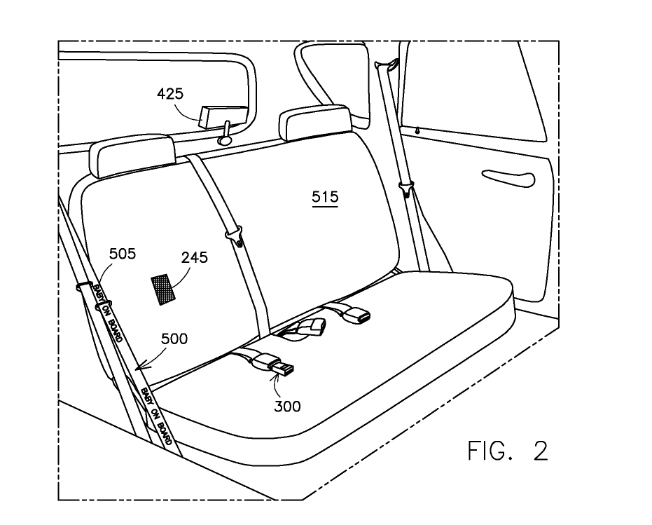

Referring now to the drawings, and more particularly to FIG. 1. The wireless safety alarm system embodying the principles and concepts of the present invention and generally designated by reference number 100 will be described.

A wireless alarm for an automobile 100, comprising a wireless carbon dioxide/smoke sensor 215, a wireless temperature sensor 211, a wireless movement sensor 205, at least one wireless warning electronic display 420, at least one wireless alarm buckle adapter 300, and a processor 235, said processor 235 further comprising a wireless transmitter 400, said transmitter 400 emitting at least one signal 435 to the internet; wherein, said processor 235 identifies that one of said wireless sensors is tripped and submits at least one signal 435 to alert that a person or child is left inside the vehicle.

Notice that the wireless alarm components although shown as interconnected by 270, this is only for explanatory purposes. All the components in the alarm system are wireless and can operate independently of each other. This is to allow to override each other if one of them does not work. All of the components are synchronized by processor 235. Being all wireless allows for easy of installation and maintenance.

The wireless alarm will send a signal when said wireless smoke sensor 215 detects high levels of carbon monoxide. The wireless temperature sensor 211 comprises at least one thermocouple. The wireless movement sensor 205 uses LED to generate photons 296 at different frequencies. The electronic display 425 light up when the alarmed is tripped and displays “baby on board.” The wireless alarm buckle adapter 300 further comprises a male and a female belt plug.

The processor 235 send distress signals to the head light 285, back lights 290, and horn 405 of the vehicle. As shown in FIG. 5, The electronic displays are located in the rear of the vehicle, 425 in the dash display 420, and in the transmission selector handle 420. The wireless transmitter 400 ends at least one signal to at least one database on the internet, to at least one radio receiver or cell phone 436, and to at least one local emergency agency or police department 440.

The wireless alarm system, herein further comprises the steps of: sensing motion using a motion sensor 205, sensing smoke or carbon dioxide using a smoke/carbon dioxide sensor 215, and sensing temperature using a temperature sensor 211. Analyzing the said motion sensor, said smoke sensor, temperature sensor using a processor 235, and using a wireless transmitter 400 to send at least one signal 435 to the internet using a wireless transmitter 400 when the sensors conditions have been.

FIGS. 1, 1A and 1B illustrates the elements of the present invention 100; comprising a wireless cabin electronic processor unit 200 presently illustrated as mounted in the ceiling cabin car 110 and secured in the cabin 150, includes a wireless movement sensor 205 able to emits photons and/or a frequency wave 296, a frequency receiver 210 able to receive the signal 297 emitted by the movement sensor 205 by means of a reflector 245, a wireless smoke/CO2 detector 215, a wireless emergency lamp 220 able to emit a visual flashing signal 260, electrical or wireless connections 270, a reset and testing button 230, an electronic circuit and components board processor 235 for receive, process and send electronic signals. The system is mounted in the car ceiling with a demountable fastener 240 presently illustrated as a double face glue tape.

In one embodiment, the wireless alarm-buckle adapter 300 is connected wirelessly to the electronic board processor 235, it comprises a male plug 310 which is able to be plugged in a female seat belt plug 320, and receive a male seat belt plug 305.

In yet another embodiment of the invention comprises an electrical and/or wireless electronic connection from the electronic board processor 235 to the handle transmission switch selector 415, to the front light beams 285 and the tail light 290 which are able to emit flashing lights 280 in a interval of time with diverse intensity. At the same time the door locks 430 are set on ready to open position. The alarm is further wirelessly or in the alternative electrically connected to: 1) a rear electronic display 425 mounted in the rear windshield, 2) a dash display 420 integrated or mounted in the car dash with a warning illuminated sign reading “baby on board”; 3) a wireless electronic radio signal transmitter 400 able to emit a localizable signal 435. The electronic wireless radio signal transmitter 400 sends a signal to a: a) database on the internet, b) radio receiver 436 or cell phone, and c) to the local emergency agency and/or police department 440, this includes also by an audible means 405. The power source presently illustrated as the car battery 410.

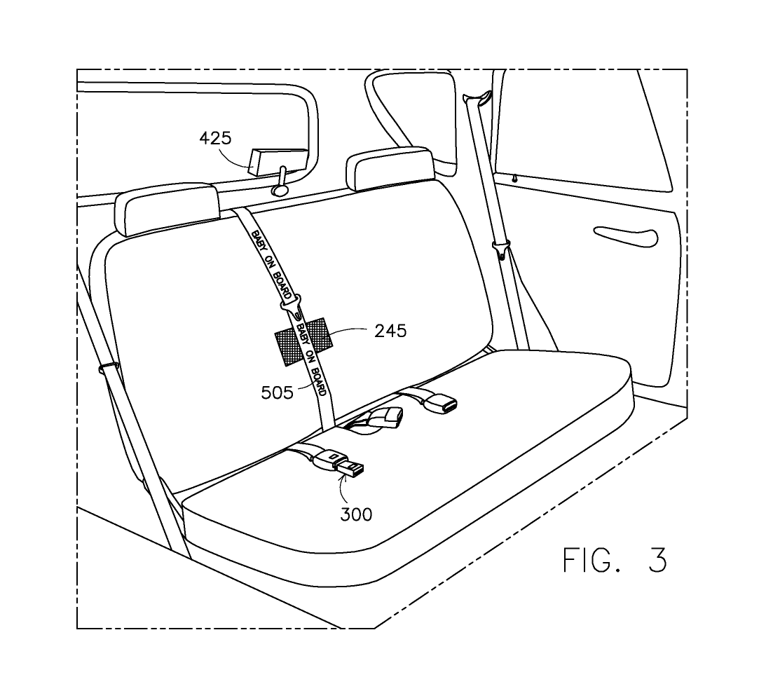

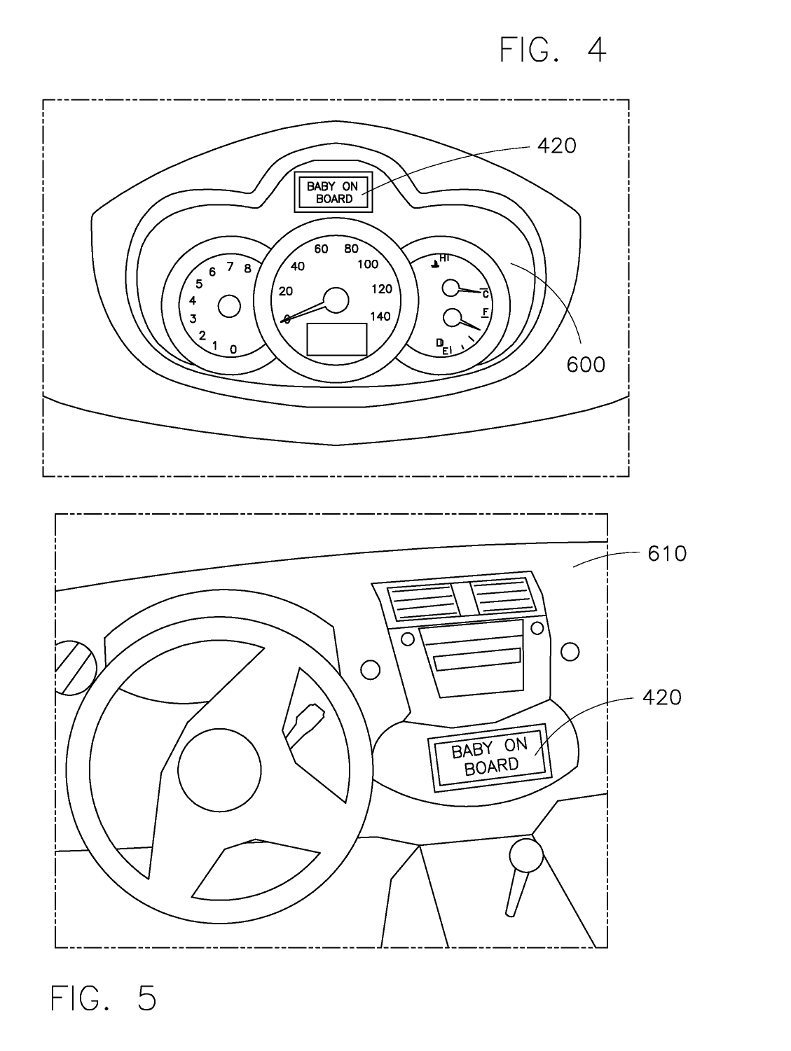

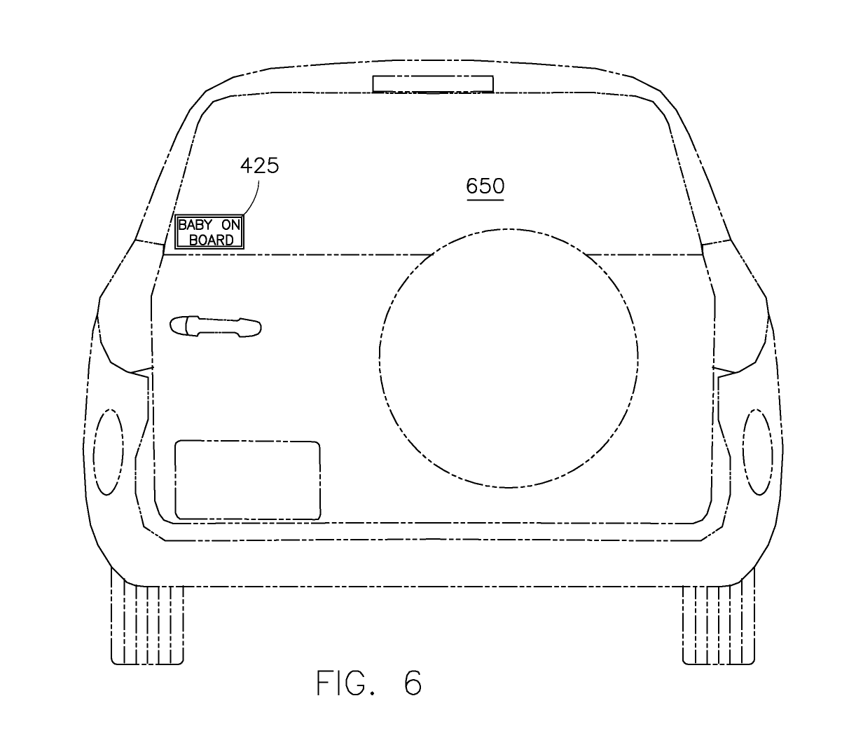

According to the invention herein, there are several options for choose a seat belt 500 to be marked with a warning text 505 for the purpose of the invention, as is illustrated in the FIGS. 2 and 3. Here, it also illustrates the relative location of the reflector 245 attached to the back of the seat 515. The wireless male-female buckle adapter is shown as 300, and the rear display 425. FIGS. 4 and 5 illustrate a relative location of the front display 420, which can be integrated to the analog instrument display 600 FIG. 4, or temporarily attached to the dash board panel as illustrate the 600 FIG. 5. FIG. 6 illustrates the wireless rear display 425, which can be watched through the rear glass 650.

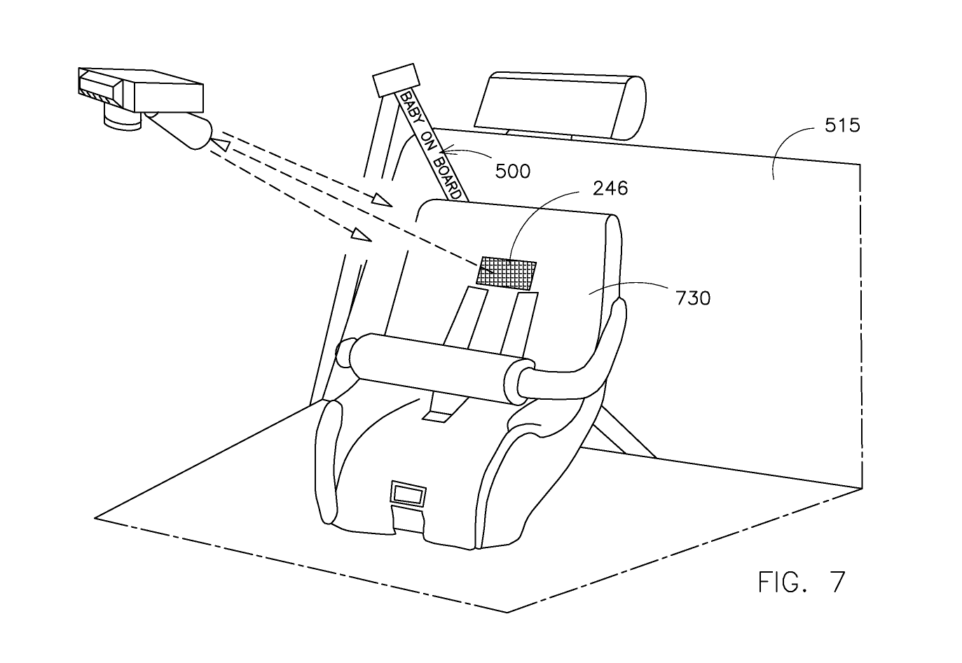

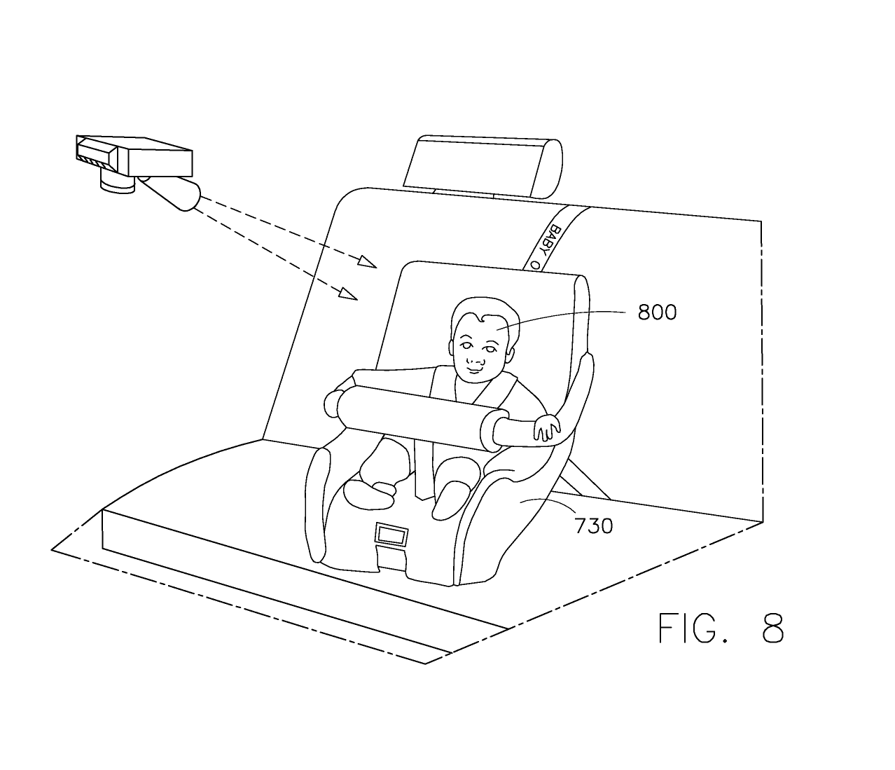

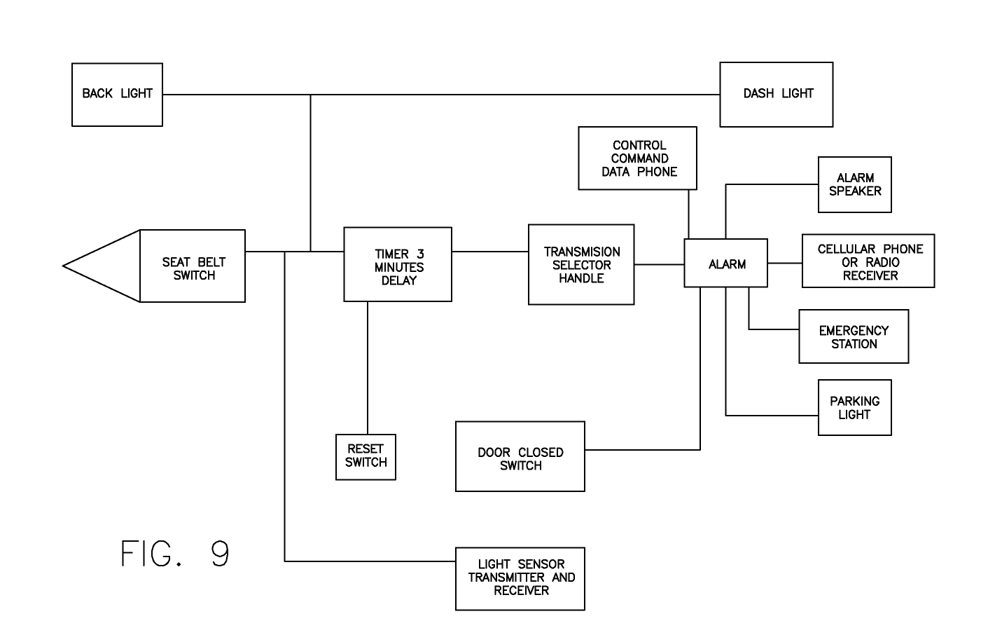

In one embodiment of the invention, the referred now to the drawing FIGS. 7 and 8. In operation, the alarm system 100 is first testing by pushing the testing button 230 (FIG. 1B). In response the emergency lamp 220 produces a convenient and pre-determinate numbers of flashings; if the system is ready to work.

A person or an infant car seat 730 is placed within a vehicle, on the rear seat 515, and buckles it with the preselected seat belt 500. As an alternative embodiment, the reflector 245 is covered and can't reflect any frequenciated light. In the case of a human body (no drawing figures) the alarm is now in activated orientation. In the case of an infant car seat 730 the alarm 100 is now activated due that the infant seat 730. The seat has been provided with a second reflector 246 which is able to reflect the light processed by the electronic processor 235 for the purpose of activating the alarm system 100. This condition allows the driver to maintain the infant 730 attached to the rear seat 515 even when none infant have being transported, without risk of put the alarm in active orientation. The buckle adapter 300 provide a second signal to the processor for avoid false alarm since maybe the driver or his/her passengers carry articles which are set in the rear seat 515 and may cover the reflector 245. If the driver planning to transport any article in the rear seat, then the adapter 300 is not necessary.

FIG. 8 illustrates an infant 800 placed in the infant car seat 730, notice that the infant body covers the reflector, thus the alarm is set in activated orientation due that the frequenciated light emit from the movement sensor 205 can't return to the receiver 210. Alternative motion sensors technologies may function the same way to accomplish the same results.

In one embodiment of the invention the signal 435 is sent wirelessly to the internet via a cellular antenna. A server will match the particular alarm code from each vehicle to at least one phone that has been pre-set at installation. This to alert multiple people using their cellphones.

In one embodiment of the invention, a first on-alarm condition is when the baby or infant is being transported or the ignition switch is selected in an “on” position, here the alarm is in activated; the rear display 425 is turned on, and an illuminated, readable and visible sign reading “baby on board.” This alerts others drivers on the street of the presence of a baby inside the car.

In a second embodiment of the invention, a second on-alarm condition is activated when the driver transports a passenger and the concentration of monoxide of carbon represents a risk to the health of the driver or passenger. Even if driving or not, the smoke/carbon monoxide detector 215 will turn the alarm on. Then the lamp 220 will flash along with a siren or speakers 405, which will emit messages for assistance. The front 285 and tail light 290 will also flash. This condition permits the driver to take decide for safety, or to call the attention of other persons to assist.

A third embodiment of the inventions is a third on-alarm condition. When the infant or adult with is in the rear seat and the driver has finished the parking operation, then the front display 420 is illuminated and begins to flash to call the attention of the driver. If the driver ignores this condition and leave the car, or set the ignition key switch in the off position, a pre-determinate amount of time will be given to take out the baby or person from the car in order to avoid activation of the alarm or the reset button 230 will have to be pushed to avoid a false alarm.

A fourth embodiment of the invention, is a fourth on-alarm condition. If the driver forgot the passenger or the driver has a health condition that does not permit him to take the passenger out from the car. Then the alarm will turn on, then the alarm emit a radio frequency signal to at least one portable radio receiver 436. It will also emit a signal to the fire rescue department 440, the door lock switch from locking door position to open door position, the speaker(s) emit a message requesting help, the front and tail light flash.

It is to be appreciated that the Detailed Description section, and not the Abstract section, is intended to be used to interpret the claims. The Abstract section may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

What is claimed is:

1. A wireless alarm for an automobile, comprising:
a. a wireless smoke sensor,
b. a wireless temperature sensor,
c. a wireless movement sensor,
d. at least one wireless warning electronic display,
e. at least one wireless alarm buckle adapter, and
f. a processor, said processor further comprising a wireless transmitter, said transmitter emitting at least one signal to the internet;
wherein, said processor identifies that one of said wireless sensors is tripped and submits at least one signal to alert that a person or child is left inside the vehicle.

2. The wireless alarm of claim 1, wherein said wireless smoke sensor detects high levels of carbon monoxide.

3. The wireless alarm of claim 1, wherein said wireless temperature sensor comprises at least one thermocouple.

4. The wireless alarm of claim 1, wherein said wireless movement sensor uses LED to generate photons at different frequencies.

5. The wireless alarm of claim 1, wherein said at least one electronic display light up when the alarmed is tripped and displays “baby on board.”

6. The wireless alarm of claim 1, wherein said at least one wireless alarm buckle adapter further comprises a male and a female belt plug.

7. The wireless alarm of claim 1, wherein said processor send distress signals to the head light, back lights, and horn of the vehicle.

8. The wireless alarm of claim 1, wherein said at least one electronic display is in the rear of the vehicle, in the dash display, and in the transmission selector handle.

9. The wireless alarm of claim 1, wherein said wireless transmitter sends at least one signal to at least one database on the internet, to at least one radio receiver or cell phone, and to at least one local emergency agency or police department

10. A wireless alarm system, comprising the steps of:
a. sensing motion using a motion sensor,
b. sensing smoke using a smoke sensor;
c. sensing temperature using a temperature sensor;
d. analyzing the said motion sensor, using a processor;
e. analyzing the said smoke sensor, using a processor;
f. analyzing the said temperature sensor, using a processor; and
g. using a wireless transmitter to send at least one signal to the internet using a wireless transmitter when the sensors conditions have been.

11. The wireless alarm system of claim 10, wherein said wireless smoke sensor detects high levels of carbon monoxide.

12. The wireless alarm system of claim 10, wherein said wireless temperature sensor comprises at least one thermocouple.

13. The wireless alarm system of claim 10, wherein said wireless motion sensor uses LED to generate photons at different frequencies.

14. The wireless alarm system of claim 10, wherein said wireless alarm system further comprises at least one electronic display that light up when the alarmed is tripped and displays “baby on board.”

15. The wireless alarm system of claim 10, wherein said processor send distress signals to the head light, back lights, and horn of the vehicle.

16. The wireless alarm system of claim 10, wherein said at least one electronic display is in the rear of the vehicle, in the dash display, and in the transmission selector handle.

17. The wireless alarm system of claim 10, wherein said wireless transmitter sends at least one signal to at least one database on the internet, to at least one radio receiver or cell phone, and to at least one local emergency agency or police department
